(19) United States
(12) Patent Application Publication
(10) Pub. No.: US 2025/0283577 A1
(43) Pub. Date: Sep. 11, 2025

(54) METHOD AND SYSTEM FOR STARTING A MACHINE

(71) Applicant: TRUMPF Werkzeugmaschinen SE + Co. KG, Ditzingen (DE)

(72) Inventors: Thorsten Larsen-Vefring, Stuttgart (DE); Klaus Bauer, Ditzingen (DE); Marcel Ely Gomes, Stuttgart (DE); Stefan Kerscher, Walzbachtal (DE); Axel Körner, Stuttgart (DE); Maik Messner, Kubschütz (DE); Niclas Sjödin, Bautzen (DE)

(21) Appl. No.: 19/220,137

(22) Filed: May 28, 2025

Related U.S. Application Data
(63) Continuation of application No. PCT/EP2023/081982, filed on Nov. 16, 2023.

(30) Foreign Application Priority Data
Nov. 29, 2022 (DE) 10 2022 131 462.6

(51) Int. Cl. F16P 3/14; B23Q 11/00

(52) U.S. Cl. CPC F16P 3/147; B23Q 11/0092

(57) ABSTRACT

A method for starting a machine tool includes receiving at least one start signal; outputting, after the start signal has been received, at least one acoustic and/or visual warning signal; monitoring, by at least one sensor system, at least one safety zone of the machine tool; and starting the machine tool at the earliest after a predetermined delay time after the start signal is received. The start of the machine is aborted if a hazard is detected by the sensor system.

### CROSS REFERENCE TO RELATED APPLICATIONS

This application is a continuation of International Application No. PCT/EP2023/081982 (WO 2024/115120 A1), filed on Nov. 16, 2023, and claims benefit to German Patent Application No. DE 10 2022 131 462.6, filed on Nov. 29, 2022. The aforementioned applications are hereby incorporated by reference herein.

### FIELD

The invention relates to a method for starting a machine, in particular a machine tool. The invention also relates to a system for starting a machine, in particular a machine tool.

### BACKGROUND

Machines, especially machine tools, often pose a hazard to people when in use. For example, moving parts of the machine can crush parts of a person's body or laser beams can injure people.

EP 3 865 257 A1 describes a method for monitoring and controlling an automated technical work system that works together with people.

Less complex monitoring is required when operating machines do not work together with people. However, when starting the machine, checks must be carried out to establish that there are no people in the safety zone.

### SUMMARY

In an embodiment, the present disclosure provides a method for starting a machine tool. The method includes receiving at least one start signal; outputting, after the start signal has been received, at least one acoustic and/or visual warning signal; monitoring, by at least one sensor system, at least one safety zone of the machine tool; and starting the machine tool at the earliest after a predetermined delay time after the start signal is received. The start of the machine is aborted if a hazard is detected by the sensor system.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a process sequence according to an embodiment of the present invention; and

FIG. 2 shows a schematic representation of a system according to an embodiment of the present invention.

### DETAILED DESCRIPTION

Embodiments of the present invention provide a system referred to at the outset and a method referred to at the outset which improves the level of safety when starting the machine.

The embodiments include a method for starting a machine, in particular a machine tool, wherein at least one start signal is received, wherein at least one acoustic and/or visual warning signal is output after the start signal has been received, wherein at least one safety zone of the machine is monitored by at least one sensor system, wherein the machine is started at the earliest after a predetermined delay time after the start signal is received, wherein the start of the machine is aborted if a hazard is detected by means of the sensor system.

The safety zone must be clear of people when the machine is in use. In other words, there must be no people within the safety zone when the machine is in use. A person in the safety zone represents a hazard for the person and possibly for the machine. The machine tool can be, for example, a laser cutting machine, a laser welding machine, a punching machine or a bending machine. A machine is also understood to include automation devices belonging to the machine and any storage system connected to the machine. It should be noted that the monitoring of the safety zone does not have to be perfect. In particular, there may be areas inside or underneath the machine where people may be present but which are not detected by the sensor system. The process is designed so that the warning signal encourages people in such places to leave these locations within the delay time and to move into the area monitored by the sensor system in order to abort the start of the machine.

The term “start of the machine” is used to refer to the initiation of a hazardous situation. A hazardous situation can be triggered, for example, by the movement of a machine part. An alternative example of initiating a hazardous situation is switching on or releasing a laser beam in the safety zone.

The acoustic and/or visual warning signal startles a person who is in the safety zone and may not have been detected by the sensor system. This motivates the person to trigger the sensor system and/or the startle response caused by the person's involuntary movement enables the person to be detected. The warning signal is, in a preferred embodiment, output in the immediate vicinity of the machine. This means that the warning signal can be recognized as belonging to this machine and cannot be misinterpreted as a warning signal from another machine.

Embodiments of the invention thus make it possible to increase the safety of the machine. The sensor system can detect people in the safety zone. The warning signal improves the detection of people as, for example, it can be used to startle sleeping people or to prompt people in places that are difficult or only poorly accessible to the sensor system to trigger the sensor system. This significantly reduces the likelihood of a person being injured by the machine. As the delay time gives people who cannot be detected by the sensor system time to trigger the sensor system after the warning signal, the procedure makes it possible to trigger the start of the machine remotely.

The delay time is, in a preferred embodiment, adapted to the specific machine and/or situation. For example, the delay time for a large machine with many locations that are not visible to the sensor system can be longer than for machines in which the entire safety zone is monitored by the sensor system. The delay time can also depend on which area or which part of the machine is to be moved upon starting or otherwise creates a hazardous situation. For example, the delay time can be longer for fast-moving parts of the machine than for slow-moving parts, as fast-moving parts generally pose a greater hazard. By adjusting the delay time, the delay time only lasts as long as necessary to achieve the safety gain. This increases the productivity of the machine.

The delay time is, in a preferred embodiment, at least one second long. This ensures that a person can be detected by the sensor system and the start of the machine can be aborted.

In a preferred embodiment, the delay time after the start of the warning signal output is at least one second. This ensures that the warning signal can take effect and the start of the machine can be aborted.

The warning signal is, in a preferred embodiment, output for at least one second. This ensures that the warning signal is heard by a person in the safety zone.

The sensor system, in a preferred embodiment, has a radar sensor. Radar sensors are particularly suitable for monitoring the safety zone. This is because radar sensors are particularly good at detecting movement. Motion detection is a particularly good way of detecting people.

The radar sensor is, in a particularly preferred embodiment, configured to detect micromovements. Radar sensors configured to detect micromovements are used in hospitals, for example, to monitor patients' breathing. By using a radar sensor configured to detect micromovements to monitor the safety zone, unconscious people, for example, can be detected by their breathing movements. This makes it possible to detect people who have not been startled by the warning signal.

In a preferred embodiment, the sensor system comprises a light barrier, an ultrasonic sensor, a camera, an infrared sensor, a motion sensor and/or a lidar sensor. These sensors are particularly suitable for detecting people in safety zones.

The sensor system, in a preferred embodiment, comprises several different sensors. The use of multiple sensors can improve the coverage of the safety zone. By using different sensors, the different advantages of the sensors can be utilized and detection improved. Overall, monitoring of the safety zone is significantly improved.

In a preferred embodiment, a movement within the safety zone during the delay time is detected as a hazard. Movement of the machine is, in a preferred embodiment, only permitted after the start of the machine. Any movement during the delay time therefore represents a hazard and causes the machine to abort the start.

The start signal is, in a preferred embodiment, received via a network, in particular the Internet. The procedure makes it possible to start the machine remotely via a network. The procedure means that it is not necessary to be at the machine to start it, while still ensuring safety in the safety zone.

The warning signal is, in a preferred embodiment, output acoustically as a siren and/or voice message. Sirens are widely known as a warning signal, so the warning effect is intuitive. A voice message can be used to draw attention to a specific hazard and/or a specific hazard location so that the warning signal is not dismissed as insignificant.

In a preferred embodiment, the warning signal comprises a flashing light and/or a visual marking, in particular a visual marking of the safety zone. The visual marking clearly highlights the safety zone in which nobody is allowed to be.

Furthermore, embodiments of the invention relate to a system comprising a machine, in particular a machine tool, having a safety zone, a sensor system, a control device and a warning signal output apparatus, wherein the control device is configured to output a warning signal via the warning signal output apparatus after a start signal is received, to use the sensor system to monitor the safety zone and to start the machine after a predetermined delay time, wherein the control device is configured to abort the start of the machine if a hazard is detected by means of the sensor system.

The sensor system, in a preferred embodiment, has a radar sensor, in particular a radar sensor configured to detect micromovements. The radar sensor is communicatively connected to the control device. The radar sensor is designed and configured to detect movements in at least part of the safety zone.

In a preferred embodiment, the sensor system comprises a light barrier, an ultrasonic sensor, a camera, an infrared sensor, a motion sensor and/or a lidar sensor.

The warning signal output apparatus is, in a preferred embodiment, located in the immediate vicinity of the machine.

The following description of preferred embodiments serves to explain the invention in greater detail with reference to the drawings.

Elements that are the same or have equivalent functions are provided with the same reference signs in all of the figures.

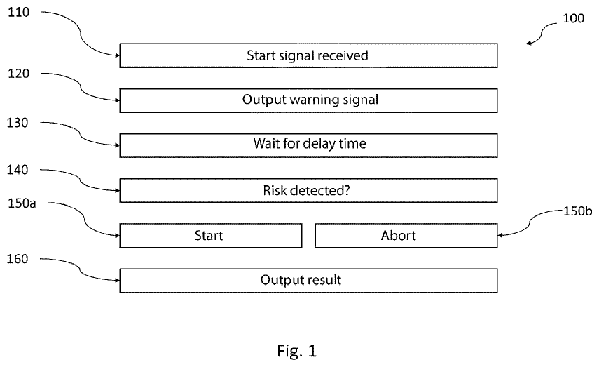

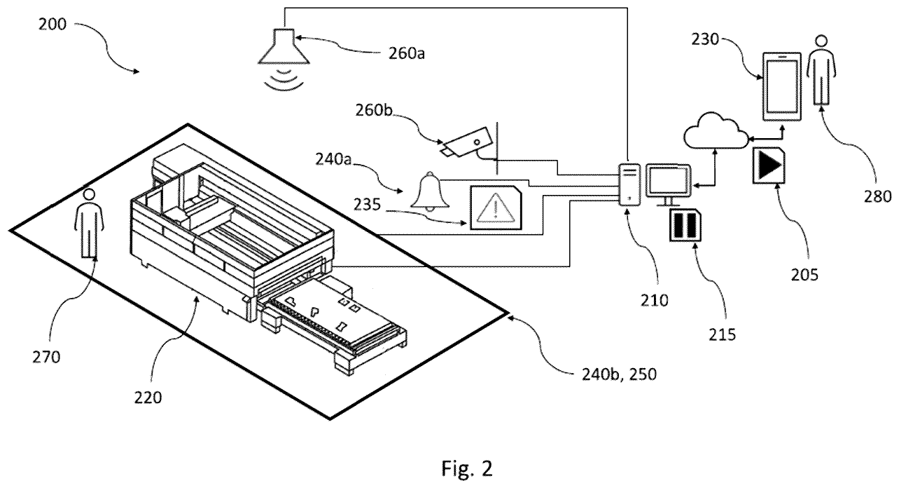

FIG. 1 shows a schematic representation of a process sequence 100. The method is explained below in connection with the schematic representation of a system 200 in FIG. 2.

In a first step 110, a start signal 205 is received. The start signal 205 is received by a control device 210 of the machine 220. The control device 210 may be part of the machine 220 or may be communicatively coupled to the machine 220 as shown in FIG. 2.

The start signal 205 can, for example, be transmitted from a remote master computer 230 to the control device 210. The master computer 230 can be connected to the control device 210 via a network 215, in particular the Internet. The master computer 230 can automatically send the start signal 205 to the control device 210 based on a program sequence, or an operator 280 can initiate the sending of the start signal 205 as shown in FIG. 2.

In a second step 120, a warning signal 235 is output. One or more warning signal output apparatus 240 are provided for outputting the warning signal 235. In FIG. 2, an acoustic warning signal output apparatus 240a and a visual warning signal output apparatus 240b are shown. The warning signal output apparatus 240 is connected to the control device 210. The warning signal 235 is sent by the control device 210 to the warning signal output apparatus 240 and output by the warning signal output apparatus 240. In this example, the acoustic warning signal output apparatus 240a is a bell that outputs a warning tone in the immediate vicinity of the machine. In this example, the visual warning signal output apparatus 240b is an illuminated strip. The illuminated strip delimits the safety zone 250. The warning tone and the illumination of the illuminated strip inform people 270 that the machine 220 is about to start and that no person 270 should be in the safety zone 250.

In a third step 130, the control device 210 waits a predetermined delay time 215 before starting the machine 220. During the predetermined delay time 215, the safety zone 250 is monitored by a sensor system 260. In this example, the sensor system 260 comprises a radar sensor 260a and additionally a camera 260b. The sensor system 260 is connected to the control device 210. The radar sensor 260a is designed to detect micromovements. With the radar sensor 260a, the control device 210 can detect unconscious persons 270 in the safety zone 250. The camera 260b captures images of the safety zone 250 and the control device 210 can use image recognition to detect people 270 or other hazards in the safety zone 250.

In a fourth step 140, the control device 210 checks whether a risk has been detected. The data recorded by the sensor system 260 can be evaluated by the respective sensor system and the information as to whether a risk has been detected can be transmitted by the sensor system to the control device 210. In a preferred embodiment, the data recorded by the sensor system 260 is transmitted to the control device 210 and the control device 210 evaluates the data recorded by the sensor system 260. The evaluation of the data by means of the control device 210 is advantageous because data from different sensor systems can be evaluated together. This can improve the detection of risks.

In a fifth step 150, after the predetermined delay time 215 has elapsed, if no risk has been detected, the machine 220 is started 150a or, if a risk has been detected, the start is aborted 150b. The machine 220 is therefore started at the earliest after the predetermined delay time 215 has elapsed and only if no risk, in particular no person 270, has been detected in the safety zone 250. In this example, a person 270 is located within the safety zone 250. The person 270 in the safety zone 250 is detected by the control device 210 by means of the sensor system 260 during the predetermined delay time 215 and the start of the machine is aborted.

In an optional sixth step 160, a result of the method 100 is output. In this example, the control device 210 sends the result, in this example the abortion of the start process, to the master computer 230. The master computer 230 can decide to initiate a new start process by sending a new start signal 205 to the control device 210, or inform an operator 280.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

100 Process sequence
110 First step
120 Second step
130 Third step
140 Fourth step
150 Fifth step
150a Starting of the machine
150b Aborting of the start
160 Sixth step
200 System
205 Start signal
210 Control device
215 Network
220 Machine
225 Delay time
230 Master computer
235 Warning signal
240 Warning signal output apparatus
240a Bel
240b Illuminated strip
250 Safety zone
260 Sensor system
260a Radar sensor
260b Camera
270 Person
280 Operator

1. A method for starting a machine tool, comprising:
receiving at least one start signal;
outputting, after the start signal has been received, at least one acoustic and/or visual warning signal;
monitoring, by at least one sensor system, at least one safety zone of the machine tool; and
starting the machine tool at the earliest after a predetermined delay time after the start signal is received,
wherein the start of the machine is aborted if a hazard is detected by the sensor system.

2. The method according to claim 1, wherein the delay time is adapted in a machine-specific and/or situation-specific manner.

3. The method according to claim 1, wherein the sensor system comprises a radar sensor.

4. The method according to claim 3, wherein the radar sensor is configured to detect micromovements.

5. The method according to claim 1, wherein the sensor system comprises a light barrier, an ultrasonic sensor, a camera, an infrared sensor, a motion sensor and/or a lidar sensor.

6. The method according to claim 1, wherein the sensor system comprises several different sensors.

7. The method according to claim 1, wherein a movement within the safety zone during the predetermined delay time is detected as the hazard.

8. The method according to claim 1, wherein the start signal is received via the Internet.

9. The method according to claim 1, wherein the warning signal is output acoustically as a siren and/or voice message.

10. The method according to claim 1, wherein the warning signal comprises a flashing light and/or a visual marking of the safety zone.

11. A system comprising a machine tool, comprising:
a safety zone;
a sensor system;
a control device; and
a warning signal output apparatus,
wherein the control device is configured to:
output a warning signal via the warning signal output apparatus after a start signal is received;
use the sensor system to monitor the safety zone; and
start the machine after a predetermined delay time,
wherein the control device is further configured to abort the start of the machine if a hazard is detected by means of the sensor system.

12. The system according to claim 11, wherein the sensor system comprises a radar sensor configured for detecting micromovements.

13. The system according to claim 11, wherein the sensor system comprises a light barrier, an ultrasonic sensor, a camera, an infrared sensor, a motion sensor and/or a lidar sensor.

14. The system according to claim 11, wherein the warning signal output apparatus is provided in the immediate vicinity of the machine.
